(19) United States
(12) Patent Application Publication
(10) Pub. No.: US 2026/0304151 A1
(43) Pub. Date: Oct. 1, 2026

(54) UE Feedback-Driven Associated ID Management and Cell Grouping System for AI/ML Model Consistency in Wireless Networks

(71) Applicant: Apple Inc., Cupertino, CA (US)

(72) Inventors: Konstantinos SARRIGEORGIDIS, Los Gatos, CA (US); Xiang CHEN, Palo Alto, CA (US)

(21) Appl. No.: 19/181,752

(22) Filed: Apr. 17, 2025

(30) Foreign Application Priority Data
Mar. 26, 2025 (GR) 20250100226

(51) Int. Cl. H04W 24/02; H04W 8/24

(52) U.S. Cl. CPC H04W 24/02; H04W 8/24

(57) ABSTRACT

An apparatus configured to process, based on signaling from a network, a configuration comprising at least a first data collection configuration with a first associated identifier (ID) and a second data collection configuration with a second associated ID, determine, based at least on first data with the first associated ID and second data with the second associated ID, that the first associated ID and the second associated ID can be grouped for a general model and generate, for transmission to the network, a grouping including the first associated ID and the second associated ID.

### BACKGROUND

Artificial intelligence (AI) and/or machine learning (ML) processes, e.g., deep learning neural networks, convolutional neural networks, etc., may be used to augment operations for the air interface in a cellular radio access network (RAN), e.g., 5G New Radio (NR) RAN, 6G RAN, etc. The use cases of AI/ML for the air interface include radio resource management (RRM) enhancements such as channel state information (CSI) feedback enhancements, e.g., overhead reduction, improved accuracy, and prediction, and beam management (BM) enhancements, e.g., beam prediction in the time and/or spatial domain for overhead and latency reduction and beam selection accuracy improvement.

### SUMMARY

Some example embodiments are related to an apparatus having memory coupled to processing circuitry, the processing circuitry configured to process, based on signaling from a network, a configuration comprising at least a first data collection configuration with a first associated identifier (ID) and a second data collection configuration with a second associated ID, determine, based at least on first data with the first associated ID and second data with the second associated ID, that the first associated ID and the second associated ID can be grouped for a general model and generate, for transmission to the network, a grouping including the first associated ID and the second associated ID.

Other example embodiments are related to an apparatus having memory coupled to processing circuitry, the processing circuitry configured to store a first model associated with a first cell of a network, process, based on signaling from a second cell of the network, a configuration for a second model associated with the second cell, test the first model in the second cell and generate, for transmission to the network, a request based on the test.

### BRIEF DESCRIPTION OF THE DRAWINGS

FIG. 1 shows a diagram for cell grouping and associated ID grouping for UE-side modeling according to various example embodiments.

FIG. 2 shows a signaling diagram for associated ID grouping for a UE-side model according to various example embodiments.

FIG. 3 shows a signaling diagram for cell ID grouping for a UE-side model according to various example embodiments.

FIG. 4 shows an example network arrangement according to various example embodiments.

FIG. 5 shows an example user equipment (UE) according to various example embodiments.

FIG. 6 shows an example base station according to various example embodiments.

### DETAILED DESCRIPTION

The example embodiments may be further understood with reference to the following description and the related appended drawings, wherein like elements are provided with the same reference numerals. The example embodiments relate to a framework for model development for models deployed by a user equipment (UE). In some example embodiments, the models can be artificial intelligence and/or machine learning (AI/ML) models. In other example embodiments, the models can be deterministically derived models (e.g., look up table, matrices, etc.). In particular, the example embodiments relate to the management of associated IDs for UE-side AI/ML model development in view of different network-side additional conditions such as, e.g., beam transmission parameters. In some aspects of the example embodiments, operations are described for grouping associated IDs based at least in part on UE evaluation of which associated IDs may be grouped, UE training a general AI/ML model for grouped associated IDs, and UE feedback to the network. In other aspects of the example embodiments, operations are described for grouping cells based at least in part on UE evaluation of whether a trained model developed in a first cell has consistent performance in a second cell and UE feedback to the network.

In each of these aspects, the UE and network operations may reduce the number of AI/ML models that are maintained by a UE while enabling a network to deploy a relatively low number of unique associated IDs and avoiding an unrealistic degree of cooperation between network vendors, e.g., inter-vendor agreement on the assignment of associated IDs.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. The example embodiments may be utilized with any network implementing AI/ML functionalities similar to those described herein, e.g., 5G-Advanced network, 6G network, etc. Therefore, the 5G NR network as described herein may represent any type of network implementing AI/ML functionalities similar to the 5G NR network.

The example embodiments are also described with reference to an AI/ML framework for the air interface. AI/ML model life cycle management (LCM) refers to the development, deployment and management of an AI/ML model. There are two main categories of AI/ML LCM in the Third Generation Partnership (3GPP) Technical Specification (TSs), in particular, functionality-based LCM and model ID-based LCM. In functionality-based LCM, a functionality refers to a feature enabled by a configuration. For both functionality-based and model ID-based LCM, the UE may store the AI/ML model (with the associated model ID or functionality/configuration) and exchange this information with the network as capability information. Each AI/ML model ID or AI/ML functionality/configuration may be associated with conditions such that the model is valid only for a particular network vendor, cell site, and/or frequency band. Generally, the number of AI/ML models stored by the UE may be kept low in order to reduce the complexity, model storage and AI/ML model transfer requirements. AI/ML models may be transferred to the UE through some collaboration with the network. These AI/ML modeling frameworks are not mutually exclusive and may be used in combination.

Some example embodiments are described with regard to AI/ML-based beam management (BM). Beam management generally refers to a set of procedures configured to acquire and maintain a beam between a network cell, e.g., a gNB or a transmission and reception point (TRP), and the UE. The terms P1, P2 and P3 refer to processes for beam management during initial access and while in the CONNECTED state. In the P1 process, the base station (e.g., gNB) performs Tx beam sweeping of synchronization signal blocks (SSBs), typically from a set of different beams, and the UE performs reception (Rx) wide beam sweeping from a set of different beams. The UE measures the signal strength (e.g., Reference Signal Received Power (RSRP)) of each of the SSBs of the received beams and selects the best beam to report to the gNB. In the P2 process, the gNB performs beam refinement by performing Tx beam sweeping of Channel State Information-Reference Signal (CSI-RS), possibly from a smaller set of beams than the P1 process, and the UE performs Rx wide beam sweeping from a set of different beams. The P2 Tx beam sweeping may be narrower than that of P1. The UE measures the signal strength (e.g., RSRP) of the CSI-RS of the received beams and selects the best beam to report to the gNB. In the P3 process the gNB (TRP) repeatedly transmits the same beam and the UE refines its Rx beam. An AI/ML model may be employed for beam prediction to reduce overhead/latency and improve beam selection. The AI/ML model may be employed for beam prediction in the time domain and/or the spatial domain.

Generalization refers to the ability of an AI/ML model to adapt properly to previously unseen data. The generalization performance of a given AI/ML model depends heavily on the configuration and parameter settings for dataset generation used for training the model. In one example, an AI/ML model trained with a dataset comprising beams transmitted with a particular codebook may have difficulties inferencing with beams transmitted with a different codebook. If the configured AI/ML functionality/model has been trained with a dataset representing certain beam transmission parameters, then this AI/ML functionality/model may experience degraded performance if different beam transmission parameters are met in the field.

The concept of additional conditions refers to non-standardized variables critical to AI/ML model training and operation. For example, in AI/ML-driven beam management, factors such as network topology (e.g., cell layout, antenna configurations) or UE-specific parameters (e.g., mobility speed) directly influence model selection during deployment. However, standardizing these variables is impractical, as they often involve proprietary implementations or sensitive operational data. Even though these variables may be used for training the AI/ML model and the AI/ML model operation requires these variables as input, these variables may not be standardized due to disclosure of proprietary information. Thus, classifying these variables as additional conditions may enable optimal AI/ ML operation.

The associated ID is configured by the network as an abstract training data identifier and is used to reflect network-side additional conditions which may not be specified. The associated ID may correspond to particular sets of beam angles, beamwidths, antenna spacing, tilt angle, etc. The network may assign a separate associated ID for various different sets of conditions that affect beam transmission. However, not every difference in network-side additional conditions or network implementation has impacts on the UE side, e.g., UE assumptions, model training and model inference. Therefore, not every different network-side additional condition requires the assignment of a separate associated ID.

It may be difficult for the network to decide how to assign associated IDs for data collection configurations, e.g., under which circumstance the network needs to assign a different associated ID for the UE to train a separate model associated with the associated ID. Current issues with the AI/ML modeling framework for the air interface include determining under which circumstances the network needs to assign a different associated ID, determining how many different associated IDs are needed, and managing the increased complexity of having different AI/ML models for each associated ID.

Current AI/ML modeling frameworks for the air interface suggest the UE may assume the model performance is consistent only within a cell. This implies the cell identification (cell ID) may be inserted into the associated ID. In other words, the associated ID is unique to the cell such that the actual associated ID comprises two elements, the cell ID and a cell-specific associated ID. If this associated ID framework is used, the UE may need to train and maintain a large number of models, e.g., one version of an AI/ML model per cell, which introduces complexities for the UE.

An alternative to the {cell ID+associated ID} framework is a framework in which each associated ID is unique to a Public Land Mobile Network (PLMN). However, this may introduce some difficulties considering inter-vendor coordination of many networks. A PLMN typically includes infrastructure from multiple vendors (e.g., Ericsson, Nokia, Huawei). If the Associated ID is unique across the entire PLMN, all vendors providing equipment for the PLMN must agree on ID assignment rules, e.g., how IDs are generated (e.g., sequential, hashing, etc.), and the semantic meaning of each ID, e.g., what each ID represents (e.g., beam codebook properties, channel conditions, etc.). In multi-vendor networks, vendors independently configure cells/sites. Without coordination, different vendors might assign conflicting IDs or interpret them differently, leading to UE misalignment.

To avoid such ID collisions, a PLMN-wide associated ID would require a centralized registry or shared algorithm to ensure uniqueness (e.g., no two vendors use the same ID for different conditions). For example, without coordination, Vendor A may assign ID=5 to a beam codebook with a 30° beamwidth, while Vendor B uses ID=5 for a 45° beamwidth.

Accordingly, one key issue relating to associated IDs is an over-assignment of Associated IDs. The network may assign distinct IDs for minor, non-impactful differences in network-side conditions (e.g., beam codebook tweaks), forcing UEs to train/maintain redundant models. Not all network differences require new IDs. Another key issue is related to the scope of associated ID consistency. Cell-specific IDs require UEs to train/manage many models (e.g., one per cell), increasing complexity, while PLMN-Wide IDs demand impractical inter-vendor coordination. Neither cell-specific IDs nor PLMN-wide IDs are optimal.

According to various example embodiments described herein, operations are described for grouping associated IDs for UE-side AI/ML models. In some example embodiments, the network provisions multiple configurations with different associated IDs during model training while enabling the UE to provide feedback on which IDs (or ID groupings) are essential for maintaining consistency. In some example embodiments, the UE determines how to develop the model and whether the model may be used for different network additional conditions, e.g., whether the model performance is consistent for multiple associated IDs. In some example embodiments, based on data collection configurations with different associated IDs, the UE may either develop independent models or a general model, e.g., by mixing the datasets of the different associated IDs. In some example embodiments, the UE may signal to the network which associated IDs were grouped into a single general model. The feedback may comprise 1) which IDs are redundant (groupable) and/or 2) whether new IDs are needed for inference.

Based on this feedback, the network may determine whether specific associated IDs are required for model inference data collection. When a general-purpose AI/ML model is developed, the utility of associated IDs diminishes significantly. The network may iteratively refine associated ID configurations, e.g., by phasing out redundant IDs, to optimize training efficiency and align with UE-reported requirements. The benefits of associated ID grouping include network optimization of ID assignments (e.g., retire unused IDs) and UEs avoiding maintaining excessive models (e.g., generalizes across IDs).

In further aspects of the example embodiments, operations are described for grouping cells such that UE-side AI/ML models trained or applied in a first cell may be used in additional cells. Cells may be grouped according to some consistent network conditions, e.g., a same vendor, beam codebook, and/or site type. In some example embodiments, the network may assign one associated ID per group. Accordingly, the UE may use the same model for multiple cells, thus reducing the UE model count. In some example embodiments, the network defines criteria for grouping cells, such as, e.g., geographical proximity or vendor ID, and validates the consistency of the model via UE feedback when switching cells.

In some example embodiments, upon transitioning to a new cell and receiving data collection configurations with a new associated ID, the UE may test the previously trained model with the new associated ID. In some example embodiments, the UE may transmit feedback to the network regarding whether the new associated ID should be retained or whether the new cell may be grouped with the previous cell, e.g., whether the model consistency holds across cells. In some example embodiments, the UE may dynamically signal to the network whether the ID is necessary for model inference. The UE may send the network an indication that this cell ID has been grouped with a different cell ID where a training model already exists. In this case, there is no need for the UE to train a new model.

This feedback mechanism allows the network to optimize ID assignments by retaining or discarding IDs based on UE-reported relevance. The feedback mechanism further streamlines configurations by eliminating redundant IDs during inference, reducing overhead. The feedback mechanism further adapts to mobility by adjusting ID mappings as the UEs move across cells, ensuring model consistency.

The benefits of cell grouping according to the present embodiments include avoiding inter-vendor coordination. For example, PLMN-Unique IDs would require global agreement across all vendors (e.g., Ericsson, Huawei, Nokia) in the PLMN to assign and interpret IDs consistently. In the Cell Grouping proposal, IDs are unique only within a subset of cells (e.g., cells managed by a single vendor or in a specific region). For example, Vendor A may reuse ID=5 in their cell group, while Vendor B uses ID=5 in theirs, with no conflict.

Cell grouping further reduces scalability challenges and simplifies UE model management. PLMN-Unique IDs require a centralized ID registry (e.g., for thousands of cells), leading to ID exhaustion (finite ID range for large PLMNs) and potentially forcing UEs to maintain thousands of models (one per unique ID), increasing complexity and memory. In the Cell Grouping proposal, IDs are reused across groups, avoiding registry bloat. For example, a PLMN with 10,000 cells may reuse IDs in 100-cell groups (only 100 unique IDs needed). The UEs train models per cell group, not per ID.

Cell grouping further supports dynamic network changes. PLMN-Unique IDs require global reconfiguration if a vendor updates ID mappings (e.g., new beam codebook). In the Cell Grouping proposal, changes are localized. A vendor updates IDs in their group without impacting others. For example, Vendor A adds a new beamwidth (15°) and assigns ID=20 in their group, with no need to notify Vendor B.

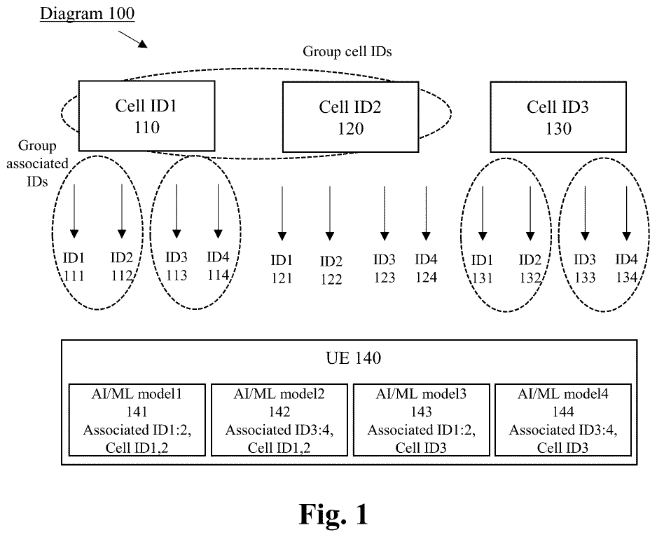

FIG. 1 shows a diagram 100 for cell grouping and associated ID grouping for UE-side modeling according to various example embodiments. The diagram 100 includes a first cell 110 with cell ID1, a second cell 120 with cell ID2, a third cell 130 with cell ID3, and a UE 140. In this example, each of the three cells 110-130 transmits four training data sets associated with respective associated IDs, e.g., the first cell 110 transmits a first training data set 111 with associated ID1, a second training data set 112 with associated ID2, a third training data set 113 with associated ID3, and a fourth training data set 114 with associated ID4; the second cell 120 transmits a first training data set 121 with associated ID1, a second training data set 122 with associated ID2, a third training data set 123 with associated ID3, and a fourth training data set 124 with associated ID4; and the third cell 130 transmits a first training data set 131 with associated ID1, a second training data set 132 with associated ID2, a third training data set 133 with associated ID3, and a fourth training data set 134 with associated ID4.

In this example, the cell ID1 corresponding to the first cell 110 is grouped with the cell ID2 corresponding to the second cell 120, while the cell ID3 corresponding to the third cell 130 is not grouped with any other cell IDs. The first cell 110 and second cell 120 may be grouped according to network implementation according to network conditions such as, e.g., a same vendor providing both cells, a same codebook, etc. Accordingly, an AI/ML model developed with training data from either or both of the first cell 110 and the second cell 120 is consistent, e.g., may generalize, across both cells.

Additionally, for the first cell 110, the associated ID1 corresponding to the first training data set 111 is grouped with the associated ID2 corresponding to the second training data set 112 and the associated ID3 corresponding to the third training data set 113 is grouped with the associated ID4 corresponding to the fourth training data set 114. Similarly, for the third cell 130, the associated ID1 is grouped with the associated ID2 and the associated ID3 is grouped with the associated ID4. Due to the cell grouping between the first cell 110 and the second cell 120, the associated IDs of the second cell 120 are grouped according to the groupings of the first cell 110.

In view of the above, the UE 140 may develop general AI/ML models using any one or more of the grouped training data sets. In this example, the UE 140 may develop a first AI/ML model 141 with any one or more of the training data sets corresponding to ID1 of the first cell 110, ID2 of the first cell 110, ID1 of the second cell 120, and ID2 of the second cell 120; a second AI/ML model 142 with any one or more of the training data sets corresponding to ID3 of the first cell 110, ID4 of the first cell 110, ID3 of the second cell 120, and ID4 of the second cell 120; a third AI/ML model 143 with any one or both of the training data sets corresponding to ID1 and ID2 of the third cell 130; and a fourth AI/ML model 144 with any one or both of the training data sets corresponding to ID3 and ID4 of the third cell 130.

The above-described scheme may be implemented by coordination between the UE and the network. In various embodiments, the UE may signal groupings of associated IDs to the network so that the network may optimize future configurations.

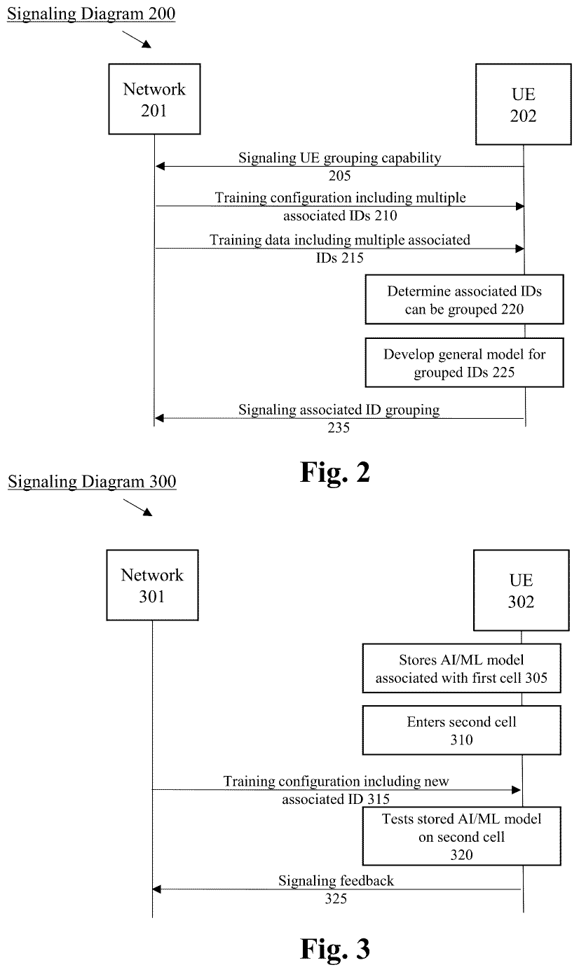

FIG. 2 shows a signaling diagram 200 for associated ID grouping for a UE-side model according to various example embodiments. The signaling diagram 200 includes a network 201, e.g., a gNB, and a UE 202.

In 205, the UE 202 signals to the network 201 a capability for grouping associated IDs. In some example embodiments, the grouping capability may comprise elements of a UE-NR-Capability (3GPP TS 38.306). In some example embodiments, these capability elements include whether associated ID grouping is supported, a maximum number of associated ID groups, and/or a maximum number of associated IDs per group. For example, for BM-Case1, the UE 202 may signal a BeamCase1Capability: {“supportedGrouping”: true, “maxGroups”: 8, “maxIDsPerGroup”: 12}.

In 210, the UE 202 receives a configuration from the network 201 for AI/ML model training including multiple associated IDs for training multiple AI/ML models. For example, a first associated ID may correspond to a first beam width and a second associated ID may correspond to a second beam width. The multiple associated IDs may be configured via radio resource control (RRC) signaling.

In 215, the UE 202 receives training data with the multiple associated IDs. In 220, the UE 202 determines which associated IDs may be grouped. For example, the UE 202 may train separate models for each of the associated IDs and identify which IDs share similar beam properties, e.g., IDs 1, 3, 5 share similar beam properties.

In 225, the UE 202 develops a general model for the grouped IDs. For example, the general model may be trained on the training data for associated IDs 1, 3, and/or 5, e.g., using a mixed dataset.

In 230, the UE 202 signals to the network 201 the grouping of associated IDs. In one example, the UE 202 may indicate that the associated IDs may be merged without any performance loss. In one embodiment, the associated ID grouping may be signaled by RRC Signaling (Semi-Static Grouping). A new RRC Information Element (IE), e.g., AssociatedIDGrouping, may be introduced in UEAssistanceInformation to indicate grouped IDs.

In another embodiment, the associated ID grouping may be signaled by MAC-CE (Dynamic Grouping). The MAC-CE may be used for rapid updates (e.g., during handovers). The MAC-CE Format may comprise an LCID (6 bits), a group ID (4 bits), and an associated ID bitmap (16 bits-1 bit per ID). The UE sends a MAC-CE with a bitmap (1 bit per Associated ID) to indicate which IDs belong to a group. For example, a bitmask 0b0000000000010101 functions to group IDs 0, 2, and 4 under GroupID=3.

The network 201 receiving the signaled grouping of associated IDs may optimize future configurations for the UE. The network 201 knows the associated ID and the cell ID, and further knows the group mapping signaled by the UE. In one example, assuming the prior model had {Associated ID=1, cell ID=2} mapped to GroupID=3, if the network changes the IDs to {Associated ID=2, cell ID=3}, but it knows that these will map to Group ID=3, then the network knows the UE can use the same AI/ML model. No further action is needed from the network to switch models, deactivate, etc.

In some example embodiments, for inference, the network 201 may reuse the grouping. For example, the network 201 may assign a single ID (e.g., ID1) for a group of beams, e.g., RS configured for inference. The UE may then use the general model for inference on both beams, reducing computational load relative to scenarios where a separate model is used for each beam.

In some example embodiments, the network 201 may optimize ID assignments. For example, the network 201 may retire redundant IDs and use a single associated ID for multiple additional conditions.

In various embodiments, the UE may signal groupings of cells to the network so that the network may optimize future configurations.

FIG. 3 shows a signaling diagram 300 for cell ID grouping for a UE-side model according to various example embodiments. The signaling diagram 300 includes a network 301 and a UE 302. In this example, the network 301 includes multiple cells.

In 305, the UE 302 stores an AI/ML model associated with a first cell of the network 301. In 310, the UE 302 enters a second cell of the network 301, e.g., a handover procedure is performed for handover of the UE 302 to the second cell. In 315, the UE 302 receives a configuration from the second cell for AI/ML model training including at least one associated ID.

In some cases, if the network 301 has already grouped the first cell and the second cell, the configuration from the second cell could include the same associated ID as was used in the first cell. In this case, the UE 302 may use the model developed in 310 in the second cell. In other cases, including the present example, the configuration from the second cell may include a new associated ID.

In 320, the UE 302 tests the model developed in 310 in the second cell. In 325, the UE 302 provides feedback to the network 301 based on the results of the model test. In some example embodiments, if the performance of the model in the second cell is good, the UE 302 may request to expand the cell group such that the model may be used in the second cell. In some example embodiments, if the performance of the model in the second cell is poor, the UE 302 may request the network 301 to use the associated ID from 320 for inference.

In some embodiments, to signal the cell grouping to the network, the UE can use UE assistance information and/or MAC-CE, similar to the associated ID grouping signaling discussed above. A composite ID comprising {associated ID, cell ID} can be used.

In another example embodiment, the UE may employ Uplink Control Information (UCI) to signal groupings of cells and/or associated IDs for frequent updates. A use case may comprise, e.g., frequent, small-scale updates (e.g., during beam tracking). The payload structure may comprise a Group Indicator comprising 2-4 bits (to signal pre-configured groups). The trigger may comprise network requests via DCI (e.g., UCI-request field).

By leveraging RRC, MAC-CE, or UCI, the UE may efficiently signal Associated ID groupings and cell ID groupings to the network, enabling scalable and vendor-agnostic AI/ML beam management and minimizing coordination overhead.

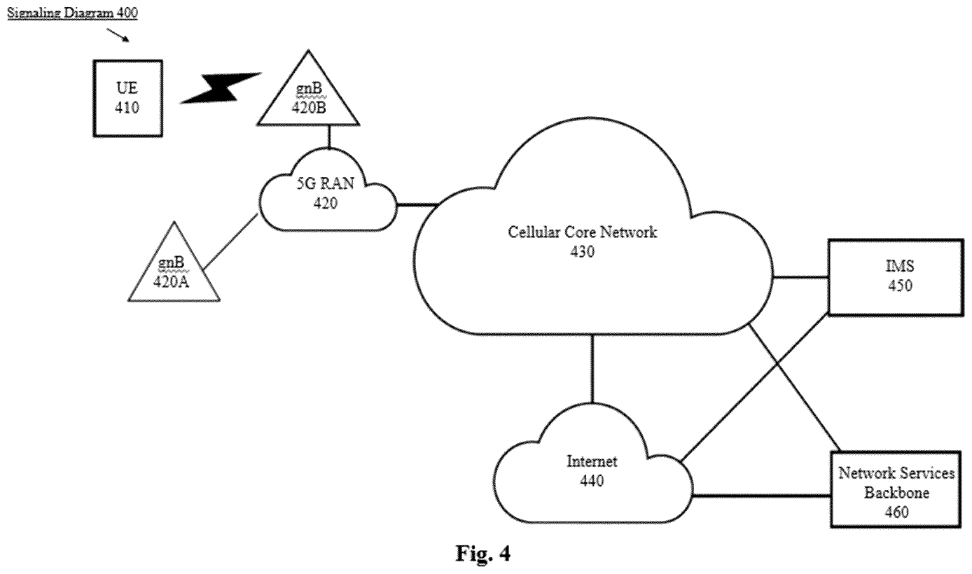

FIG. 4 shows an example network arrangement 400 according to various example embodiments. The example network arrangement 400 includes a UE 410. The UE 410 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 410 is merely provided for illustrative purposes.

The UE 410 may be configured to communicate with one or more networks. In the example of the network arrangement 400, the network with which the UE 410 may wirelessly communicate is a 5G NR radio access network (RAN) 420. However, the UE 410 may also communicate with other types of networks (e.g., 5G cloud RAN, a next generation RAN (NG-RAN), a legacy cellular network, etc.) and the UE 410 may also communicate with networks over a wired connection. With regard to the example embodiments, the UE 410 may establish a connection with the 5G NR RAN 420. Therefore, the UE 410 may have a 5G NR chipset to communicate with the NR RAN 420.

The 5G NR RAN 420 may be portions of a cellular network that may be deployed by a network carrier (e.g., Verizon, AT&T, T-Mobile, etc.). The RAN 420 may include cells or base stations that are configured to send and receive traffic from UEs that are equipped with the appropriate cellular chip set. In this example, the 5G NR RAN 420 includes the gNB 420A and the gNB 420B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 410 to connect to the 5G NR RAN 420. For example, as discussed above, the 5G NR RAN 420 may be associated with a particular network carrier where the UE 410 and/or the user thereof has a contract and credential information (e.g., stored on a SIM card). Upon detecting the presence of the 5G NR RAN 420, the UE 410 may transmit the corresponding credential information to associate with the 5G NR RAN 420. More specifically, the UE 410 may associate with a specific cell (e.g., gNB 420B).

The network arrangement 400 also includes a cellular core network 430, the Internet 440, an IP Multimedia Subsystem (IMS) 450, and a network services backbone 460. The cellular core network 430 manages the traffic that flows between the cellular network and the Internet 440. The IMS 450 may be generally described as an architecture for delivering multimedia services to the UE 410 using the IP protocol. The IMS 450 may communicate with the cellular core network 430 and the Internet 440 to provide the multimedia services to the UE 410. The network services backbone 460 is in communication either directly or indirectly with the Internet 440 and the cellular core network 430. The network services backbone 460 may be generally described as a set of components (e.g., servers, network storage arrangements, etc.) that implement a suite of services that may be used to extend the functionalities of the UE 410 in communication with the various networks.

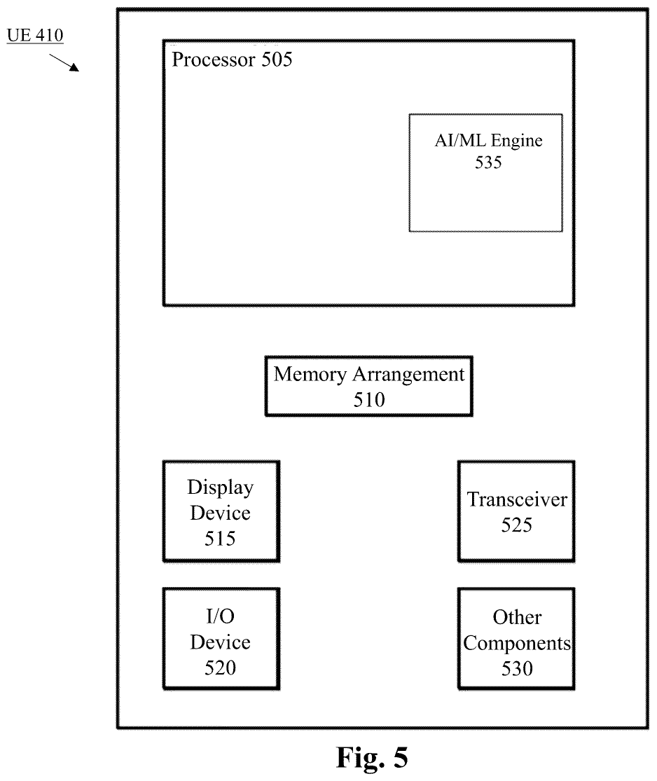

FIG. 5 shows an example UE 410 according to various example embodiments. The UE 410 will be described with regard to the network arrangement 400 of FIG. 4. The UE 410 may represent any electronic device and may include a processor 505, a memory arrangement 510, a display device 515, an input/output (I/O) device 520, a transceiver 525, and other components 530. The other components 530 may include, for example, an audio input device, an audio output device, a battery that provides a limited power supply, a data acquisition device, ports to electrically connect the UE 410 to other electronic devices, sensors to detect conditions of the UE 410, etc.

The processor 505 may be configured to execute a plurality of engines for the UE 410. For example, the engines may include an AI/ML engine 535 for performing operations related to model development for UE-side AI/ML models for the air interface, as described in detail above.

In some examples, beam measurement inputs may be fed to the AI/ML engine 535. The AI/ML engine 535 may include one or more learning-based and/or non-learning-based models for perceiving, synthesizing, and inferring information. The AI/ML engine 535 may include any suitable number of processes to predict a beam in the spatial or temporal domain based on input beam measurement data.

Persons of ordinary skill in the art will appreciate that the AI/ML engine 535 may include any suitable machine learning models that are well-known or widely available such as regression techniques, classification techniques, neural networks, and deep learning networks. In instances where the AI/ML engine 535 comprises a machine-learning based model, the AI/ML engine 535 may be trained to predict a beam based on beam measurement data using one or more well-known or widely available training techniques such as supervised learning, semi-supervised learning, unsupervised learning, and/or reinforcement learning techniques. The training data may include the aforementioned beam measurement data.

The above referenced engine being an application (e.g., a program) executed by the processor 505 is only an example. The functionality associated with the engines may also be represented as a separate incorporated component of the UE 410 or may be a modular component coupled to the UE 410, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 505 is split among two or more processors such as a baseband processor and an applications processor. The example embodiments may be implemented in any of these or other configurations of a UE.

The memory arrangement 510 may be a hardware component configured to store data related to operations performed by the UE 410. The display device 515 may be a hardware component configured to show data to a user while the I/O device 520 may be a hardware component that enables the user to enter inputs. The display device 515 and the I/O device 520 may be separate components or integrated together such as a touchscreen.

The transceiver 525 may be a hardware component configured to establish a connection with the 5G NR-RAN 420, an LTE-RAN (not pictured), a legacy RAN (not pictured), a WLAN (not pictured), etc. Accordingly, the transceiver 525 may operate on a variety of different frequencies or channels (e.g., set of consecutive frequencies). The transceiver 525 includes circuitry configured to transmit and/or receive signals (e.g., control signals, data signals). Such signals may be encoded with information implementing any one of the methods described herein. The processor 505 may be operably coupled to the transceiver 525 and configured to receive from and/or transmit signals to the transceiver 525. The processor 505 may be configured to encode, decode and/or process signals (e.g., signaling from a base station of a network) for implementing any one of the methods described herein.

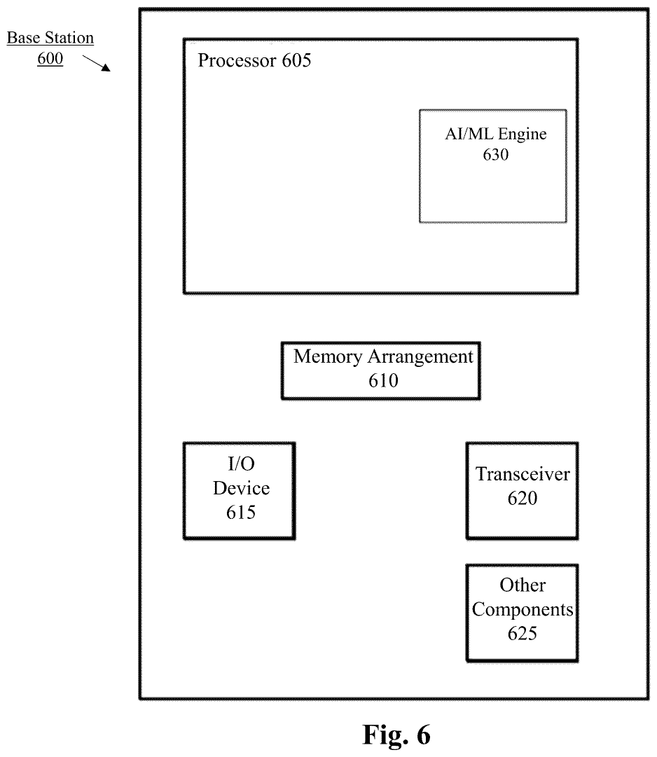

FIG. 6 shows an example base station 600 according to various example embodiments. The base station 600 may represent the gNB 420A, the gNB 420B or any other access node through which the UE 410 may establish a connection and manage network operations. The base station 600 may operate as the MN or the SN as described in the examples above.

The base station 600 may include a processor 605, a memory arrangement 610, an input/output (I/O) device 615, a transceiver 620, and other components 625. The other components 625 may include, for example, an audio input device, an audio output device, a battery, a data acquisition device, ports to electrically connect the base station 500 to other electronic devices and/or power sources, etc.

The processor 605 may be configured to execute a plurality of engines for the UE 410. For example, the engines may include an AI/ML engine 630 for performing operations related to model development for UE-side AI/ML models for the air interface, as described in detail above.

The memory arrangement 610 may be a hardware component configured to store data related to operations performed by the base station 600. The I/O device 615 may be a hardware component or ports that enable a user to interact with the base station 600.

The transceiver 620 may be a hardware component configured to exchange data with the UE 410 and any other UE in the network arrangement 400. The transceiver 620 may operate on a variety of different frequencies or channels (e.g., set of consecutive frequencies). The transceiver 620 includes circuitry configured to transmit and/or receive signals (e.g., control signals, data signals). Such signals may be encoded with information implementing any one of the methods described herein. The processor 605 may be operably coupled to the transceiver 620 and configured to receive from and/or transmit signals to the transceiver 620. The processor 605 may be configured to encode, decode and/or process signals (e.g., signaling from a UE) for implementing any one of the methods described herein.

### EXAMPLES

In a first example, a method, comprising processing, based on signaling from a network, a configuration comprising at least a first data collection configuration with a first associated identifier (ID) and a second data collection configuration with a second associated ID, determining, based at least on first data with the first associated ID and second data with the second associated ID, that the first associated ID and the second associated ID can be grouped for a general model and generating, for transmission to the network, a grouping including the first associated ID and the second associated ID.

In a second example, the method of the first example, wherein the grouping including the first associated ID and the second associated ID is transmitted to the network via radio resource control (RRC) signaling.

In a third example, the method of the second example, wherein the grouping including the first associated ID and, wherein the RRC signaling includes an information element in UE assistance information.

In a fourth example, the method of the first example, wherein the grouping including the first associated ID and, wherein the grouping including the first associated ID and the second associated ID is transmitted to the network via medium access control (MAC) control element (MAC-CE).

In a fifth example, the method of the fourth example, wherein the grouping including the first associated ID and, wherein the MAC-CE includes an associated ID bitmap indicating the first associated ID and the second associated ID.

In a sixth example, the method of the fifth example, wherein the grouping including the first associated ID and, wherein the associated ID bitmap includes a field for the associated ID bitmap comprising 16 bits, wherein each bit corresponds to a different associated ID value.

In a seventh example, the method of the fourth example, wherein the grouping including the first associated ID and, wherein the MAC-CE further includes a group ID field.

In an eighth example, the method of the first example, wherein the grouping including the first associated ID, the method further comprising signaling, to the network, a grouping capability for a functionality.

In a ninth example, the method of the first example, wherein the grouping including the first associated ID and, wherein the grouping capability includes elements for a maximum number of groups or a maximum number of associated IDs per group.

In a tenth example, a processor configured to perform any of the methods of the first through ninth examples.

In an eleventh example, a user equipment (UE) configured to perform any of the methods of the first through ninth examples.

In a twelfth example, a method, comprising storing a first model associated with a first cell of a network, processing, based on signaling from a second cell of the network, a configuration for a second model associated with the second cell, testing the first model in the second cell and generating, for transmission to the network, a request based on the test.

In a thirteenth example, the method of the twelfth example, wherein, when the first model is consistent in the second cell, the request indicates the first cell and the second cell can be grouped.

In a fourteenth example, the method of the twelfth example, wherein, when the first model is not consistent in the second cell, the request indicates a new associated identifier (ID) should be assigned for inference in the second cell.

In a fifteenth example, the method of the twelfth example, wherein the request is transmitted to the network via radio resource control (RRC) signaling.

In a sixteenth example, the method of the fifteenth example, wherein the RRC signaling includes an information element in UE assistance information.

In a seventeenth example, the method of the twelfth example, wherein the request is transmitted to the network via medium access control (MAC) control element (MAC-CE).

In an eighteenth example, the method of the seventeenth example, wherein the MAC-CE includes a bitmap indicating the first cell and the second cell.

In a nineteenth example, a processor configured to perform any of the methods of the twelfth through eighteenth examples.

In a twentieth example, a user equipment (UE) configured to perform any of the methods of the twelfth through eighteenth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising memory coupled to processing circuitry, the processing circuitry configured to:
process, based on signaling from a network, a configuration comprising at least a first data collection configuration with a first associated identifier (ID) and a second data collection configuration with a second associated ID;
determine, based at least on first data with the first associated ID and second data with the second associated ID, that the first associated ID and the second associated ID can be grouped for a general model; and
generate, for transmission to the network, a grouping including the first associated ID and the second associated ID.

2. The apparatus of claim 1, wherein the grouping including the first associated ID and the second associated ID is transmitted to the network via radio resource control (RRC) signaling.

3. The apparatus of claim 2, wherein the RRC signaling includes an information element in UE assistance information.

4. The apparatus of claim 1, wherein the grouping including the first associated ID and the second associated ID is transmitted to the network via medium access control (MAC) control element (MAC-CE).

5. The apparatus of claim 4, wherein the MAC-CE includes an associated ID bitmap indicating the first associated ID and the second associated ID.

6. The apparatus of claim 5, wherein the associated ID bitmap includes a field for the associated ID bitmap comprising 16 bits, wherein each bit corresponds to a different associated ID value.

7. The apparatus of claim 4, wherein the MAC-CE further includes a group ID field.

8. The apparatus of claim 1, wherein the processing circuitry is further configured to:
signal, to the network, a grouping capability for a functionality.

9. The apparatus of claim 8, wherein the grouping capability includes elements for a maximum number of groups or a maximum number of associated IDs per group.

10. An apparatus comprising memory coupled to processing circuitry, wherein the processing circuitry is configured to:
store a first model associated with a first cell of a network;
process, based on signaling from a second cell of the network, a configuration for a second model associated with the second cell;
test the first model in the second cell; and
generate, for transmission to the network, a request based on the test.

11. The apparatus of claim 10, wherein, when the first model is consistent in the second cell, the request indicates the first cell and the second cell can be grouped.

12. The apparatus of claim 10, wherein, when the first model is not consistent in the second cell, the request indicates a new associated identifier (ID) should be assigned for inference in the second cell.

13. The apparatus of claim 10, wherein the request is transmitted to the network via radio resource control (RRC) signaling.

14. The apparatus of claim 13, wherein the RRC signaling includes an information element in UE assistance information.

15. The apparatus of claim 10, wherein the request is transmitted to the network via medium access control (MAC) control element (MAC-CE).

16. The apparatus of claim 15, wherein the MAC-CE includes a bitmap indicating the first cell and the second cell.
